(19) United States
(12) Patent Application Publication
(10) Pub. No.: US 2018/0190079 A1
(43) Pub. Date: Jul. 5, 2018

(54) BACCARAT VERSION OF 4-CARD PAI GOW

(71) Applicant: Phujohn Nguyen, Las Vegas, NV (US)

(72) Inventor: Phujohn Nguyen, Las Vegas, NV (US)

(21) Appl. No.: 15/395,080

(22) Filed: Dec. 30, 2016

(51) Int. Cl. G07F 17/32; A63F 1/00; A63F 13/493

(52) U.S. Cl. CPC G07F 17/3293; A63F 2250/58; A63F 1/00; G07F 17/3216; G07F 17/3246; G07F 17/3209; G07F 17/3211; G07F 17/3248; G07F 17/3258; G07F 17/3241; A63F 13/493; A63F 2001/001; A63F 2001/005; A63F 2001/008; G07F 17/3288

(57) ABSTRACT

A wagering event blending elements of Pai Gow and baccarat is performed. After a wager at a player position, four random playing cards are provided as a set to a player position and a set at a dealer position. Each set of cards is divided into a 3-card high baccarat hand and a 1-card baccarat hand. Both high and low hands at the dealer position and player position are compared to determine a winning outcome.

### BACKGROUND OF THE INVENTION

### 1. Field of the Invention

The present invention relates to wagering games and particularly wagering games using playing cards as random outcome generators.

### 2. Background of the Art

Baccarat is one of the many live table games played in casinos or gaming establishments. Baccarat uses one or more standard decks of 52 playing cards and is usually dealt from a shoe having multiple decks that have been shuffled together prior to the beginning of play. The object of the game of Baccarat is for the better to successfully wager on whether the Bank's hand or the Player's hand is going to win. The bettor receives even money for his wager if he selects the winning hand and loses his wager if he selects the losing hand. Because of the rules of play of Baccarat and more particularly the pre-established draw rules, the Bank's hand has a slightly higher chance of winning than does the Player's hand. The winning frequency for the Bank's hand has been determined to be 0.45859 (45.859%) whereas the winning frequency for the Player hand is 0.44624 (44.624%) with the remainder of the outcomes being ties. Therefore, if the bettor wagers on the Bank's hand and the Bank hand wins, the bettor must pay to the gaming establishment a commission (typically, 5%) of the amount the bettor wins. No commission is paid if the bettor successfully wagers on the Player's hand.

As used in this specification, the term “Conventional Manner of Play of Baccarat” is as follows:

A multiple number of decks of standard playing cards, 52 in number, are used; typically eight decks, or 416 playing cards, are shuffled together and placed in a shoe from which the cards are dealt during the play of the game.

Each bettor makes a wager on whether the Bank's hand or the Player's hand will win. After all wagers are made, two cards are dealt from the shoe to the Bank position and two cards are dealt from the shoe to the Player position on the table layout. The cards are turned face up and the value of the Bank hand the Player hand is determined, modulo ten.

Aces count one; Kings, Queens, Jacks and Tens count zero and the other cards count their respective face value. The suits (Spades, Hearts, Diamonds and Clubs) have no meaning in Baccarat.

The highest hand value in Baccarat is nine. All hand values range from a low of zero to a high of nine. If when the cards are added together, the total of the hand exceeds nine, then the hand value is determined modulo ten. For example, a seven and an eight total fifteen, but the hand value is five. An Ace and a nine total ten, but the hand value is zero.

A two card total of eight or nine is called a “natural”; a two card total of zero is called a “baccarat.” As will be explained below, in certain situations in the play of the game, a third card will be dealt. The value of this third card is added to the total of the first two cards and a new hand value is established. Again, if the new hand total exceeds nine, the hand value is determined by subtracting ten from the total of the hand.

Prior to the deal, each better can make one of three wagers: 1) that the Bank hand will win; 2) that the Player hand will win; or 3) that the Bank hand and the Player hand will tie. Wagering locations are provided on the Baccarat table layout. Whichever of the Bank hand or the Player hand is closest to a total on nine is the winner.

All winning Bank hand wagers are paid off at odds of one-to-one and the house charges a five percent (5%) commission on the amount won by the bettor. For example, if a bettor wagers $100 on the Banker hand and the Banker hand wins, the bettor wins $100 and is charged a $5 commission on the amount that the bettor won.

All winning Player hand wagers are paid off at odds of one-to-one and the bettor is not charged any commission on the amount of his winnings or his wager because the house, by virtue of the third card draw rules, has a statistical advantage over the player of 45.859-44.624 or 1.235% which is the vigorish (“vig”) of the house on player wagers. Winning wagers on the Tie hand bet are paid off at odds of nine-to-one or eight-to-one (depending on the gaming establishment) and the bettor is not charged any commission on the amount of his winnings or his wager since there is already a statistical advantage in favor of the house on tie wagers. If a Tie hand occurs, all wagers on the Bank hand and all wagers on the Player hand are “pushes” and the amount wagered is returned to the bettor.

Depending on the point total of the Player position's hand and the Banker position's hand, an additional card may be dealt to either the Player position's hand, the Banker position's hand or both. The rules for determining whether a third card is dealt are fixed rules, there is no discretion for either the Player position's hand or the Banker position's hand on whether a third card is dealt.

If either the Player hand or the Banker hand has a point total of eight or nine on the first two cards, no third card is dealt to either hand and the hand with the highest point total is the winner (or the hand is a Tie, as the case may be). If neither the Player hand nor the Banker hand has a point total of eight or nine, then there is a possibility of a third card draw.

The third card draw rules are as follows:

Rule #1: If the initial two card Player hand has a point total of 0, 1, 2, 3, 4 or 5, the Player hand draws a third card. If the initial two card Player hand has a point total of 6 or 7, the Player hand stands and does not receive a third card.

Rule #2: If the Player hand stands and does not draw a third card, then the Banker hand follows Rule #1. In other words, if the Player hand has a point total of 6 or 7, the Bank hand draws a third card on a point total of 0, 1, 2, 3, 4 or 5 and the Bank hand stands on a point total of 6 or 7.

Rule #3: If the Player hand draws a third card, the Bank hand must draw or stand as follows:

TABLE 1
BACCARAT RULES
PLAYER

| HAVING TWO CARD | |
|---|---|
| TOTAL OF | |
| 1-2-3-4-5-10 | DRAWS A CARD |
| 6-7 | STANDS |
| 8-9 | TURNS CARDS OVER |

BANKER

| | | DOES NOT DRAW |
|---|---|---|
| HAVING | DRAWS WHEN GIVING | WHEN GIVING OR |
| TWO CARD | OR PLAYER'S THIRD | PLAYER'S THIRD CARD |
| TOTAL OF | CARD DRAW IS AN | DRAW IS AN |
| 0, 1, 2 | ALWAYS DRAWS | |
| 3 | 1-2-3-4-5-6-7-9-10 | 8 |
| 4 | 2-3-4-5-6-7 | 1-8-9-10 |
| 5 | 4-5-6-7 | 1-2-3-8-9-10 |
| 6 | 6-7 | 1-2-3-4-5-8-9-10 |

| | |
|---|---|
| 7 | STANDS |
| 8-9 | TURNS CARDS OVER |

At the end of each hand, winning wagers are paid and losing wagers are collected by the house. Any commission due to the house is marked in commission boxes in the center of the table. Gaming chips are used to represent the amount of money owed by each bettor to the house for the commissions. In order not to slow down the game, the commission is not actually collected from each bettor until the end of the round determined by all of the cards in the shoe being dealt down to the plastic cut card, usually approximately eighty hands.

The mathematical analysis of the game reveals that the 5% commission is what gives the house its advantage on wagers on the Banker hand and allows the gaming establishment to make a profit from providing the Baccarat game to the bettors. Because the rules for standing and drawing third cards are automatic, the mathematical analysis shows that the Bank hand will win 45.859% of the hands, the Player hand will win 44.624% of the hands and the Tie hand will occur 9.517% of the hands. If the Tie hands are disregarded because they do not affect any Player or Bank wagers, it is then determined that the Bank hand will win 50.7% of the time and the Player hand will win 49.3% of the time.

Because the Bank hand wins more than 50% of the hands (disregarding the Tie hands that do not affect any Player or Bank wagers), if a bettor always bet on the Bank hand, the bettor would have an advantage over the gaming establishment. By charging a 5% commission on all Bank hand wins, the gaming establishment compensates for the percentage of winning Bank hands being slightly over 50%.

After figuring in the 5% commission that must be paid by bettors on winning Bank hands, the gaming establishment has approximately a 1.23% advantage over the bettor when the bettor wagers on the Player hand and the gaming establishment has a 1.057% advantage over the bettor when the bettor wagers on the Bank hand. The Tie hand wager gives the gaming establishment a 4.88% advantage over the bettor when the payoff odds are nine-to-one and a 14.1% advantage over the bettor when the payoff odds are eight-to-one.

One of the detriments of the conventional manner of play of Baccarat is the necessity for calculating, recording and collecting this 5% commission on all winning Bank hand wagers. Many people are reluctant to sit down and participate because they do not understand why they should have to pay a 5% commission on winning Bank hand wagers. They may consider this unfair and something extra for the gaming establishment.

The gaming establishments also suffer disadvantages from the 5% commission. The determination of the 5% amount is done visually by a casino dealer and is subject to casino dealer error and disputes with the bettors over the amount of the commission. The reconciliation and collection of the commission at the end of each shoe can result in delays of the beginning of the next round of play. If a bettor loses all of his money (“taps out”) during a round of the game, the gaming establishment may have difficulty collecting the unpaid commission that has accrued to that bettor during that round of the game. It has been estimated that as much as twenty percent of the accrued commission goes uncollected. Because the house margin on Baccarat is so small, uncollected commissions can seriously impact the profitability of a Baccarat table or the entire Baccarat pit, if more than one table is in play. In certain situations a bettor will negotiate with the casino for the casino to forgive or discount the owed commissions, the quid pro quo being that the player will likely return to the casino in the future.

It has been desirable to eliminate commissions in baccarat, and this has been attempted in a number of different ways.

U.S. Pat. Nos. 5,979,896 and 5,362,064 (LoFink) disclose a modified method of playing either conventional Baccarat, or a modified Baccarat game with simplified draw rules is provided which can eliminate the commission charged to winning Bank hands by providing a partial payoff on one or more Bank winning outcomes. Further the method of the present invention can operate upon the Player hand as well to adjust the vigorish therefor. The method can be used to provide a no-commission game where the vigorish for the Bank and Player hands are substantially the same. Further the vigorish can be adjusted to at least partially fund a jackpot outcome.

U.S. Pat. Nos. 6,585,586 and 6,582,302 (Romero) describes a method and gaming assembly to play a variation of the game baccarat, the gaming assembly including a computer processor assembly, a display assembly and at least one user actuatable selector assembly. The computer processor assembly is structured to generate a player's hand and a banker's hand in accordance with rules of baccarat, one of those hands being designated the user's hand. Further, the computer processor assembly is structured to determine a winning hand in accordance with the rules of baccarat, designating the user as a winner if the user's hand is also the wining hand. Additionally, the computer processor assembly is structured to monitor consecutive ones of the user's hands and to indicate a bonus payout to the user in the event that consecutive ones of the user's hands have a final number count equal to a natural nine.

### SUMMARY OF THE INVENTION

A method of playing a wagering game with physical playing cards or virtual playing cards provided by a processor displaying cards on a display screen after the processor recognizes a game wager. The method is generally described in terms of a physical playing card game, but the steps in the electronic processor-based system parallel the physical playing card game. The method is practiced by:

providing a set of randomized physical (or virtual) playing cards;

receiving a single game wager on final count value outcomes of two hands at a player position for a round of play of the wagering game;

providing a first set of exactly four randomized physical (or virtual) playing cards to the player position;

providing a second set of exactly four randomized physical (or virtual) playing cards to a dealer position;

using only last digit values of combinations of the playing cards to determine point values of two hands in each of the player position and the dealer position, the two hands comprising a first one-card low hand and a second three-card high hand, wherein the final total point count of the first hand must be lower than (or optionally inclusive of equal to) the total point count of the second hand;

organizing the player position four randomized playing cards into the two player position hands comprising a first one-card low hand and a second three-card high hand;

organizing the dealer position four randomized playing cards into the two dealer hands comprising a first one-card low hand and a second three-card high hand;

comparing the final total count of the first player position hand to the final total count of the first hand at the dealer position and the final total count of the second player position hand to the final total count of the second hand at the dealer position;

the single game wager being resolved as follows:
a) if the first player position hand and the second player position hand both have higher final total counts higher than those of the first dealer position hand and the second dealer position hand, respectively, the game wager is won by the player position at 1:1 odds;
b) i) if the first player position hand and the second player position hand consist of one hand having a final total count higher than its respective hand of the dealer position, and if the other of the player position hands has a same or lower final total point count as its respective dealer position hand, the game wager is a push or
   ii) if the first player position hand and the second player position hand consist of one hand having a final total count higher than its respective hand of the dealer position, and if the other of the player position hands has a same final total point count as its respective dealer position hand, the game wager is won by the player position or the dealer position based on winning of the non-same hand, and if both hands of the player position and both respective hands of the dealer position tie, the game wager is lost; and
c) if the first player position hand and the second player position hand both have lower or equal final total counts higher than those of the first dealer position hand and the second dealer position hand, respectively, the game wager is lost by the player position.

### BRIEF DESCRIPTION OF THE FIGURES

FIG. 1 shows an electronic gaming table on which the gaming method may be executed.

FIG. 1A shows a schematic for an electronic system for enabling play of the gaming method described herein.

FIG. 1B shows another schematic for an electronic system for enabling play of the gaming method described herein.

### DETAILED DESCRIPTION OF THE INVENTION

A method of enabling and concluding a wagering event with physical playing cards includes steps of:

providing a set of randomized physical playing cards;

receiving a single game wager on final count value outcomes of two hands at a player position for a round of play of the wagering game;

providing a first set of exactly four randomized physical playing cards to the player position;

providing a second set of exactly four randomized physical playing cards to a dealer position;

using only last digit values of combinations of playing cards to determine point values of two hands in each of the player position and the dealer position, the two hands comprising a first one-card low hand and a second three-card high hand, wherein the final total point count of the first hand must be lower than the total point count of the second hand;

organizing the player position four randomized playing cards into the two hands comprising a first one-card low hand and a second three-card high hand;

organizing the dealer position four randomized playing cards into the two hands comprising a first one-card low hand and a second three-card high hand;

comparing the final total count of the first player position hand to the final total count of the first hand at the dealer position and the final total count of the second player position hand to the final total count of the second hand at the dealer position;

the single game wager being resolved as follows:
a) if the first player position hand and the second player position hand both have higher final total counts higher than those of the first dealer position hand and the second dealer position hand, respectively, the game wager is won by the player position at 1:1 odds;
   b) if the first player position hand and the second player position hand consist of one hand having a final total count higher than its respective hand of the dealer position, and if the other of the player position hands has a same or lower final total point count as its respective dealer position hand, the game wager is a push;
   c) if the first player position hand and the second player position hand both have lower or equal final total counts higher than those of the first dealer position hand and the second dealer position hand, respectively, the game wager is lost by the player position.

There are species variations allowed within the scope of the present generic technology. These include situations where:

If the player ties one respective hand with the dealer and wins the other respective hand, the wager is paid even money.

If the player ties one respective hand with the dealer and loses the other respective hand to the dealer, the wager is lost.

If the player ties both respective hands with the dealer, the wager is lost.

Also, it is desirable that the dealer must follow these rules when setting the 3 card high hand and the 1 card low hand. The dealer generally is required to make the biggest (largest value up to 9, or another target number) possible 3 card hand and place the remaining card in the one card hand. An alternate dealer method for setting the 3 card high hand and the 1 card low hand would require the dealer to make the biggest (largest value up to 9, or another target number) possible 1 card hand that is equal than or smaller to the 3 card high hand.

The method may be played wherein when an unsettable hand occurs (as explained and defined by example herein), the game wager is resolved by:
A) If the player position is dealt an unsettable hand the player position loses the hand; and
B) If the dealer position is dealt an unsettable hand, the all player position wagers in the round of play push regardless of the count in the player position hand (if the player position also has an unsettable hand in this situation. The rules can be made so that the player position still loses, or the player position gets a push.

The method may include a side bet placed on the presence of one or more unsettable hands, wherein upon occurrence of an unplayable four-card player position hand pays according to a first paytable on the game wager, unless the dealer position hand is also an unsettable hand and then the unsettable player position hand will be paid odds against a second paytable on the game wager.

The method may include a side bet placed on the presence of one or more unsettable hands, wherein upon occurrence of an unsettable four-card dealer position hand pays according to a paytable on the game wager, unless the player position hand is also an unsettable hand which will pay odds against a paytable on the game wager. In an embodiment of this method, the first paytable pays different odds for one unplayable player position hand as compared to another unsettable player position hand and all unsettable hands are selected from the group consisting of four 7s, four 8s and four 9s. The first paytable may pay different odds for different combinations of one unsettable player position hand as compared to one other unsettable dealer position hand and all unsettable hands are selected from the group consisting of four 7s, four 8s and four 9s.

A side bet wager may be placed at the player position in addition to the game wager, and the side bet wager may be resolved on the basis of a 4-card poker rank in the player position hand against a paytable.

A method of playing the wagering game described herein may be enabled with virtual playing cards displayed on a display screen according to direction by a processor after the processor receives a single game wager from a player position, the method comprising:

the processor providing a virtual set of randomized virtual playing cards;

the processor receiving the single game wager on final count value outcomes of two hands formed from virtual playing cards at a player position for a round of play of the wagering game;

the processor providing a first set of exactly four randomized virtual playing cards to the player position;

the processor providing a second virtual set of exactly four randomized virtual playing cards to a dealer position;

the processor using only last digit values of combinations of virtual playing cards to determine point values of two virtual hands in each of the player position and the dealer position, the two virtual hands comprising a first virtual one-card low hand and a second virtual three-card high hand, wherein the final total point count of the first virtual hand must be lower than the total point count of the second virtual hand;

organizing the player position four randomized virtual playing cards into the two virtual hands comprising a first virtual one-card low hand and a second virtual three-card high hand;

organizing the dealer position four virtual randomized playing cards into the two virtual hands comprising a first virtual one-card low hand and a second virtual three-card high hand;

comparing the final total count of the first player position virtual hand to the final total count of the first virtual hand at the dealer position and the final total count of the second player position hand to the final total count of the second virtual hand at the dealer position;

the single game wager being resolved as follows:
a) if the first player position virtual hand and the second player position virtual hand both have higher final total counts higher than those of the first dealer position hand and the second dealer position hand, respectively, the game wager is won by the player position at 1:1 odds;
b) if the first player position virtual hand and the second player position virtual hand consist of one hand having a final total count higher than its respective hand of the dealer position, and if the other of the player position virtual hands has a same or lower final total point count as its respective dealer position virtual hand, the game wager is a push;
c) if the first player position virtual hand and the second player position virtual hand both have lower or equal final total counts higher than those of the first dealer position virtual hand and the second dealer position virtual hand, respectively, the game wager is lost by the player position.

In a method of playing a wagering outcome event with physical playing cards, the steps of the process comprising:

providing a set of randomized physical playing cards;

receiving a single wagering outcome event wager on final count value outcomes of two hands at a player position for a round of play of the wagering game;

providing a first set of exactly four randomized physical playing cards to the player position;

providing a second set of exactly four randomized physical playing cards to a dealer position;

using only last digit values of combinations of playing cards to determine point values of two hands in each of the player position and the dealer position, the two hands comprising a first one-card low hand and a second three-card high hand, wherein the final total point count of the first hand must be lower than the total point count of the second hand;

organizing the player position four randomized playing cards into the two hands comprising a first one-card low hand and a second three-card high hand;

organizing the dealer position four randomized playing cards into the two hands comprising a first one-card low hand and a second three-card high hand;

comparing the final total count of the first player position hand to the final total count of the first hand at the dealer position and the final total count of the second player position hand to the final total count of the second hand at the dealer position;

the single wagering event outcome wager being resolved as follows:
a) if the first player position hand and the second player position hand both have higher final total counts higher than those of the first dealer position hand and the second dealer position hand, respectively, the game wager is won by the player position at 1:1 odds;
b) if one of the first player position hand and the second player position hand have a final total count that ties the final total count of its respective hand of the dealer position, the higher final total count of the other of the first and second respective hands determines winning or losing outcomes and if the other of the respective other hands tie, the side bet wager is a push, a player win or a dealer win according to a game rule; and
c) if the first player position hand and the second player position hand both have lower final total counts than those of the first dealer position hand and the second dealer position hand, respectively, the game wager is lost by the player position.

The game, generally referred to herein as “PaiBacc” is played with a standard 52 card deck or multiple standard 52-card decks.

A Player position makes at least a first wager on an underlying game. A Player position and dealer position each receive four cards. Using Baccarat scoring rules, the player and dealer each must make a three-card high hand and a one-card low hand. The low hand cannot have a greater point total than the high hand (it may have the same point total as the high hand).

After the player position has set the player position hand according to those rules, the dealer position reveals the cards and sets the player position hand according to the same principles. The at least a first wager is resolved as follows:
If the player's position high and low hand beat the dealer's position high and low, the player position wins even money.
If one of the player position hands beats one of the dealer's position respective hands and loses the other respective hand, the wager is pushed.
If the player position ties one of the dealer's position respective hands and wins against the other respective hand, the wager wins even money.
If the player position ties or loses to one of the dealer's position respective hands and loses against the other respective hand, the wager is lost.

Unsettable hand rule: Occasionally, the player and the dealer will be dealt four cards that cannot be set according to the game's rules (in other words, using baccarat scoring there is no possible way to set a three card high hand that has a bigger or equal total to a one card low hand as with four 7s, four 8s and four 9s). In this situation, the hand will be resolved in the following fashion:

Player: If the player position is dealt four cards that cannot be arranged to produce a 3-card high hand that has a greater-than or equal total to the 1-card low hand the player position loses the hand.

Dealer: If the dealer position is dealt four cards that cannot be arranged to produce a 3-card high hand that has a greater-than or equal total to the 1-card low hand, the all player positions in the hand push regardless of their own hand (if the player position also has an unsettable hand in this situation, the rules can be made so that the player position still loses, or the player position gets a push).

Side Bet: There is an opportunity for a unique paytable-based side bet that centers around the probability of either the player, the dealer, or both being dealt an unsettable hand.

The random playing card symbols may alternatively be provided by a processor having a random number generator, and virtual playing card symbols, and then displayed on a display device, the processor and display device contained in a housing, and wagers and playing card activity on player hands is directed through a player input system.

The virtual method may be played wherein each of the player position exactly the correct number of initial cards in a player position hand and the dealer position exactly the correct number of virtual cards for a dealer position hand. These are initially virtually dealt to each of the player position and the dealer position or wherein each of the player position exactly correct number of virtual playing cards in the player hand and the dealer position exactly correct number of virtual playing cards in the dealer/banker hand are initially virtually dealt to and displayed at each of the player position and the dealer position as exactly the correct number of virtual playing cards each and third virtual cards are virtually delivered from the randomized set of virtual playing cards upon demand for any further virtual playing cards at each of the player position and the dealer position.

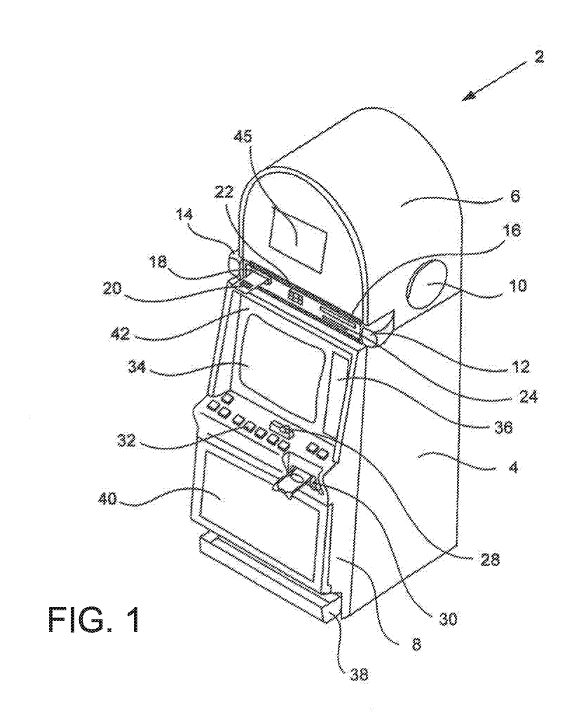

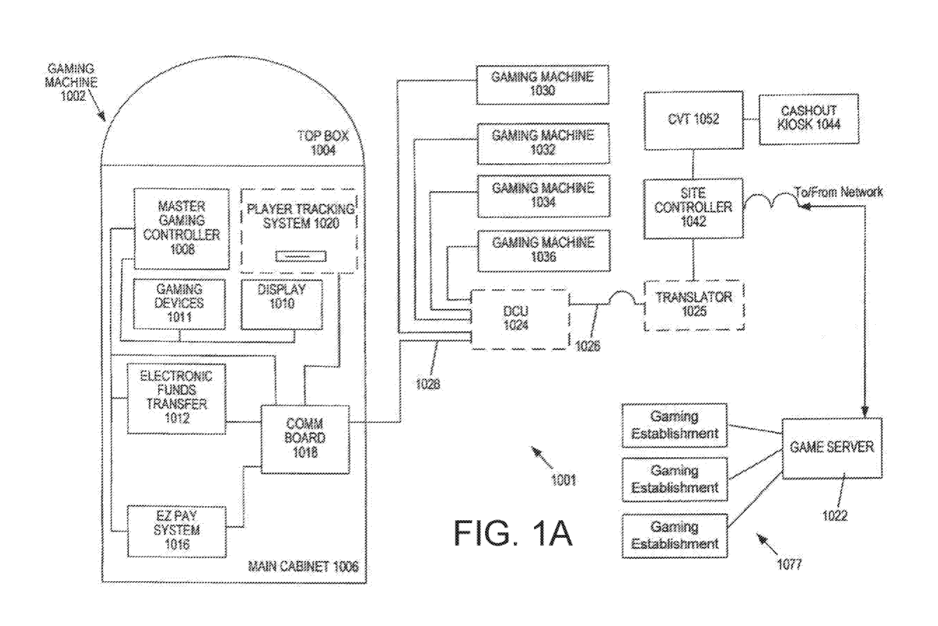

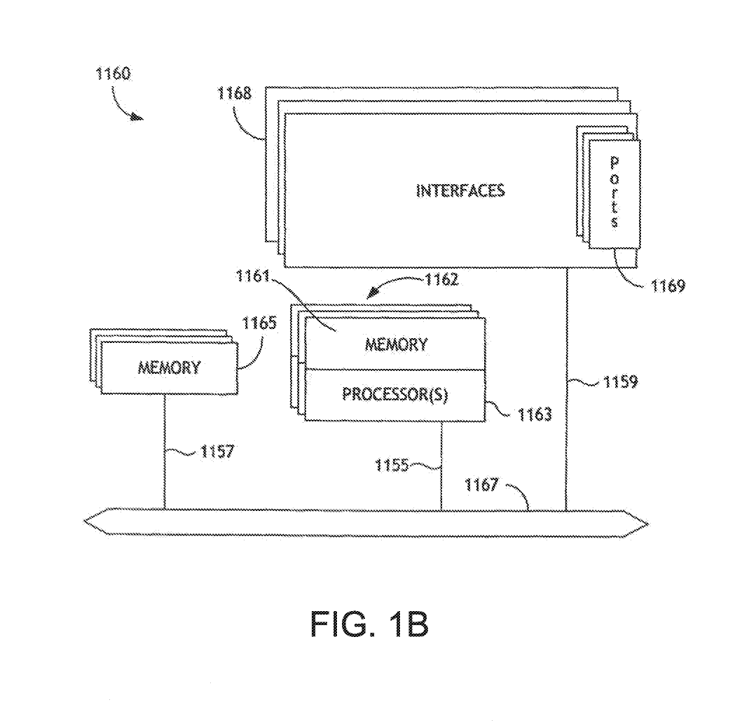

Turning next to FIG. 1, a video gaming machine 2 that may be used as the underlying base gaming counsel of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaining machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog tinier circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as :mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

As the gaming technology is based on wagering, there must be a basis for entering and recording wagers and their winning, losing and tie outcomes. In video gaming or multiplayer platform gaming systems, value-in-value-out wagering components may be used. Among such components include ticket-in-ticket-out systems with scanners and printers, currency acceptors with scanners and in communication with a value verification system that includes an ability to visually display accepted and verified value, coin or token drop-in systems with coin valuation and recognition and an ability to visually display accepted and verified value. Credit cards, debit cards and smart cards with electronic chips or memory in them may also be used by insertion into a slot on the gaming systems which has electronic reading capability that is matched to the electronic card inserted into the slot. This system will also enable an ability to visually display accepted and verified value.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

The CPU system may perform additional functions unique to the operation of the present gaming system. The CPU may be engaged with flow meters to measure rates or flow of liquid, volume of total water in the system (by measuring volume in the reservoir when a lowest amount of fluid is in the container and pipes, determination of proportionate payouts dependent upon fluid levels and execution of unique game code. A densitometer in the fluid flow path may be present to determine deterioration in color density or discoloration of the fluid due to contamination, and an alarm is sounded when the color quality (density, tone, wavelengths of absorption and the like) varies beyond predetermined parameters.

One method of playing a wagering game with virtual playing cards on a system including a player input control, a value-in-value out component, a video display component, a game processor and memory, the method including:

providing a set of randomized physical playing cards;

receiving a single game wager through the value-in-value-out component that receives and recognizes value committed on final count value outcomes of two hands at a player position for a round of play of the wagering game, and displaying an amount of value committed on the single game wager;

the processor providing a first set of exactly four randomized virtual playing cards to the player position and displaying them on the video display component;

providing a second set of exactly four randomized virtul playing cards to a dealer position;

the processor using only last digit values of combinations of the first set and the second set of virtual playing cards to determine point values of two hands in each of the player position and the dealer position, the two hands comprising a first one-card low hand and a second three-card high hand, wherein the final total point count of the first hand must be lower than the total point count of the second hand;

the player through action on the player input control organizing the player position four randomized playing cards into the two hands comprising a first one-card low hand and a second three-card high hand and displaying them on the video display component;

the processor exercising strategy stored in memory, organizing the dealer position four randomized playing cards into the two hands comprising a first one-card low hand and a second three-card high hand and displaying them on the video display component;

the processor comparing the final total count of the first player position hand to the final total count of the first hand at the dealer position and the final total count of the second player position hand to the final total count of the second hand at the dealer position;

the single game wager being resolved by the processor as follows:
a) if the first player position hand and the second player position hand both have higher final total counts higher than those of the first dealer position hand and the second dealer position hand, respectively, the game wager is won by the player position at 1:1 odds;
b) if one of the first player position hand and the second player position hand have a final total count that ties the final total count of its respective hand of the dealer position, the higher final total count of the other of the first and second respective hands determines winning or losing outcomes and if the other of the respective other hands tie, the side bet wager is a push, a player win or a dealer win according to a game rule; and
c) if the first player position hand and the second player position hand both have lower final total counts than those of the first dealer position hand and the second dealer position hand, respectively, the game wager is lost by the player position;

the processor registering winning outcome amounts, losing outcome amounts and any tie events determined by resolution of the processor.

Those skilled in the gaming and video gaming arts will be aware of the availability of existing and improving technology that may be used as alternatives within the generic concepts enabled herein in the practice of the present invention. Among such changes could be additional side bet wagers, specialty cards added to the original set of playing cards, and the like.

What is claimed:

1. A method of playing a wagering game with virtual playing cards on a system including a player input control, a value-in-value out component, a video display component, a game processor and memory, the method comprising:
providing a set of randomized physical playing cards;
receiving a single game wager through the value-in-value-out component that receives and recognizes value committed on final count value outcomes of two hands at a player position for a round of play of the wagering game, and displaying an amount of value committed on the single game wager;
providing a first set of exactly four randomized virtual playing cards to the player position;
providing a second set of exactly four randomized virtul playing cards to a dealer position;
using only last digit values of combinations of the first set and the second set of virtual playing cards to determine point values of two hands in each of the player position and the dealer position, the two hands comprising a first one-card low hand and a second three-card high hand, wherein the final total point count of the first hand must be lower than the total point count of the second hand;
the player through action on the player input control organizing the player position four randomized playing cards into the two hands comprising a first one-card low hand and a second three-card high hand;
the processor exercising strategy stored in memory, organizing the dealer position four randomized playing cards into the two hands comprising a first one-card low hand and a second three-card high hand;
the processor comparing the final total count of the first player position hand to the final total count of the first hand at the dealer position and the final total count of the second player position hand to the final total count of the second hand at the dealer position;
the single game wager being resolved by the processor as follows:
a) if the first player position hand and the second player position hand both have higher final total counts higher than those of the first dealer position hand and the second dealer position hand, respectively, the game wager is won by the player position at 1:1 odds;
b) if one of the first player position hand and the second player position hand have a final total count that ties the final total count of its respective hand of the dealer position, the higher final total count of the other of the first and second respective hands determines winning or losing outcomes and if the other of the respective other hands tie, the side bet wager is a push, a player win or a dealer win according to a game rule; and
c) if the first player position hand and the second player position hand both have lower final total counts than those of the first dealer position hand and the second dealer position hand, respectively, the game wager is lost by the player position;
the processor registering winning outcome amounts, losing outcome amounts and any tie events determined by resolution of the processor.

2. The method of claim 1 wherein when an unsettable hand occurs, the game wager is resolved by:
i) If the player position is dealt an unsettable hand the player position loses the hand; and
ii) If the dealer position is dealt an unsettable hand, the all player position wagers in the round of play push regardless of the count in the player position hand.

3. The method of claim 1 wherein a side bet is placed through the player input control on the presence of one or more unsettable hands, wherein upon occurrence of an unplayable four-card player position hand pays according to a first paytable in memory on the game wager, unless the dealer position hand is also an unsettable hand and then the unsettable player position hand will be paid odds against a second paytable in memory on the game wager.

4) The method of claim 1 wherein a side bet is placed through the player input control on the presence of one or more unsettable hands, wherein upon occurrence of an unsettable four-card dealer position hand pays according to a paytable in memory on the game wager, unless the player position hand is also an unsettabl hand which will pay odds against a paytable in memory on the game wager.

5) The method of claim 3 wherein the first paytable pays different odds for one unplayable player position hand as compared to another unsettable player position hand and all unsettable hands are selected from the group consisting of four 7s, four 8s and four 9s.

6) The method of claim 4 wherein the first paytable pays different odds against the game wager for one unsettable dealer position hand as compared to another unsettable dealer position hand and all unsettable hands are selected from the group consisting of four 7s, four 8s and four 9s.

7) The method of claim 3 wherein the first paytable pays different odds for different combinations of one unsettable player position hand as compared to one other unsettable dealer position hand and all unsettable hands are selected from the group consisting of four 7s, four 8s and four 9s.

8) The method of claim 4 wherein the first paytable pays different odds for different combinations of one unsettable player position hands as compared to one other unsettable dealer position hands and all unsettable hands are selected from the group consisting of four 7s, four 8s and four 9s.

9) The method of claim 1 wherein a side bet wager is placed at the player position in addition to the game wager, and the side bet wager is resolved on the basis of a 4-card poker rank in the player position hand against a paytable.

10) The method of claim 1 wherein a side bet wager is placed at the player position in addition to the game wager, and the side bet wager is resolved on the basis of a 4-card poker rank in the dealer position hand against a paytable in memory.

11) A method of playing a wagering game with virtual playing cards displayed on a display screen according to direction by a processor after the processor receives a single game wager from a player position, the method played on a system including a player input control, a value-in-value out component, a video display component, a game processor and memory, the method comprising the method comprising:
the processor providing a virtual set of randomized virtual playing cards;
the processor receiving the single game wager the value-in-value-out component on final count value outcomes of two hands formed from virtual playing cards at a player position for a round of play of the wagering game;
the processor providing a first set of exactly four randomized virtual playing cards to the player position and displaying them on the video display component;
the processor providing a second virtual set of exactly four randomized virtual playing cards to a dealer position and displaying them on the video display component;
the processor using only last digit values of combinations of virtual playing cards to determine point values of two virtual hands in each of the player position and the dealer position, the two virtual hands comprising a first virtual one-card low hand and a second virtual three-card high hand, wherein the final total point count of the first virtual hand must be lower than the total point count of the second virtual hand;
the processor or the player through the player input control organizing the player position four randomized virtual playing cards into the two virtual hands comprising a first virtual one-card low hand and a second virtual three-card high hand;
the processor organizing the dealer position four virtual randomized playing cards into the two virtual hands comprising a first virtual one-card low hand and a second virtual three-card high hand;
the processor comparing the final total count of the first player position virtual hand to the final total count of the first virtual hand at the dealer position and the final total count of the second player position hand to the final total count of the second virtual hand at the dealer position;
the single game wager being resolved by the processor as follows:
a) if the first player position virtual hand and the second player position virtual hand both have higher final total counts higher than those of the first dealer position hand and the second dealer position hand, respectively, the game wager is won by the player position at 1:1 odds;
b) if the first player position virtual hand and the second player position virtual hand consist of one hand having a final total count higher than its respective hand of the dealer position, and if the other of the player position virtual hands has a same or lower final total point count as its respective dealer position virtual hand, the game wager is a push; and
c) if the first player position virtual hand and the second player position virtual hand both have lower or equal final total counts higher than those of the first dealer position virtual hand and the second dealer position virtual hand, respectively, the game wager is lost by the player position.

12) A method of playing a wagering game with virtual playing cards on a system including a player input control, a value-in-value out component, a video display component, a game processor and memory, the method comprising:
providing a set of randomized physical playing cards;
receiving a single game wager through the value-in-value-out component that receives and recognizes value committed on final count value outcomes of two hands at a player position for a round of play of the wagering game, and displaying an amount of value committed on the single game wager;
the processor providing a first set of exactly four randomized virtual playing cards to the player position and displaying them on the video display component;
providing a second set of exactly four randomized virtul playing cards to a dealer position;
the processor using only last digit values of combinations of the first set and the second set of virtual playing cards to determine point values of two hands in each of the player position and the dealer position, the two hands comprising a first one-card low hand and a second three-card high hand, wherein the final total point count of the first hand must be lower than the total point count of the second hand;
the player through action on the player input control organizing the player position four randomized playing cards into the two hands comprising a first one-card low hand and a second three-card high hand and displaying them on the video display component;
the processor exercising strategy stored in memory, organizing the dealer position four randomized playing cards into the two hands comprising a first one-card low hand and a second three-card high hand and displaying them on the video display component;
the processor comparing the final total count of the first player position hand to the final total count of the first hand at the dealer position and the final total count of the second player position hand to the final total count of the second hand at the dealer position;
the single game wager being resolved by the processor as follows:
a) if the first player position hand and the second player position hand both have higher final total counts higher than those of the first dealer position hand and the second dealer position hand, respectively, the game wager is won by the player position at 1:1 odds;
b) if one of the first player position hand and the second player position hand have a final total count that ties the final total count of its respective hand of the dealer position, the higher final total count of the other of the first and second respective hands determines winning or losing outcomes and if the other of the respective other hands tie, the side bet wager is a push, a player win or a dealer win according to a game rule; and
c) if the first player position hand and the second player position hand both have lower final total counts than those of the first dealer position hand and the second dealer position hand, respectively, the game wager is lost by the player position;
the processor registering winning outcome amounts, losing outcome amounts and any tie events determined by resolution of the processor.

13) The method of claim 1 wherein organizing the dealer position four randomized virtual playing cards into the two hands comprising a first one-card low hand and a second three-card high hand is accomplished by forming a highest possible point count total with three of the four randomized virtual playing cards and placing them in a three-playing card high hand position and placing a remaining fourth card into a one-card low hand position.

14) The method of claim 2 wherein organizing the dealer position four randomized virtual playing cards into the two hands comprising a first one-card low hand and a second three-card high hand is accomplished by forming a highest possible point count total with three of the four randomized virtual playing cards and placing them in a three-playing card high hand position and placing a remaining fourth card into a one-card low hand position.

15) The method of claim 5 wherein organizing the dealer position four randomized virtual playing cards into the two hands comprising a first one-card low hand and a second three-card high hand is accomplished by forming a highest possible point count total with three of the four randomized virtual playing cards and placing them in a three-playing card high hand position and placing a remaining fourth card into a one-card low hand position.

16) The method of claim 7 wherein the processor organizes the dealer position four randomized virtual playing cards into the two hands comprising a first one-card low virtual hand and a second three-card virtual high hand is accomplished by forming a highest possible point count total with three of the four randomized virtual playing cards and placing them in a three-playing virtual card high hand position and placing a remaining fourth virtual playing card into a one-card low hand position.

17) The method of claim 9 wherein organizing the dealer position four randomized virtual playing cards into the two hands comprising a first one-card low hand and a second three-card high virtual hand is accomplished by forming a highest possible point count total with three of the four randomized virtual playing cards and placing them in a three-playing card virtual high hand position and placing a remaining fourth virtual playing card into a one-card low virtual hand position.

18) The method of claim 11 wherein the processor organizes the dealer position four randomized virtual playing cards into the two hands comprising a first virtual one-card low hand and a second virtual three-card high hand is accomplished by forming a highest possible point count total with three of the four randomized virtual playing cards and placing them in a virtual three-playing card high hand position and placing a remaining fourth virtual card into a virtual one-card low hand position.

19) The method of claim 12 wherein the processor organizes the dealer position four randomized virtual playing cards into the two hands comprising a first virtual one-card low hand and a second virtual three-card high hand is accomplished by forming a highest possible point count total with three of the four randomized virtual playing cards and placing them in a virtual three-playing card high hand position and placing a remaining fourth virtual card into a virtual one-card low hand position.

20) The method of claim 1 wherein the dealer position four randomized cards are organized forming a largest value 1-card hand that is equal to or smaller than the 3-card high hand formed from remaining cards after the 1-card hand has been formed.

21) A method of playing a wagering game with physical playing cards on a gaming table comprising:
providing a set of randomized physical playing cards;
receiving a single game wager on final count value outcomes of two hands at a player position for a round of play of the wagering game by placement of physical elements of value on the gaming table or player input on an electronic wagering system embedded in the physical gaming teble;
providing a first set of exactly four randomized physical playing cards to the player position;
providing a second set of exactly four randomized physical playing cards to a dealer position;
using only last digit values of combinations of playing cards to determine point values of two hands in each of the player position and the dealer position, the two hands comprising a first one-card low hand and a second three-card high hand, wherein the final total point count of the first hand must be lower than the total point count of the second hand;
organizing the player position four randomized playing cards into the two hands comprising a first one-card low hand and a second three-card high hand;
organizing the dealer position four randomized playing cards into the two hands comprising a first one-card low hand and a second three-card high hand;
comparing the final total count of the first player position hand to the final total count of the first hand at the dealer position and the final total count of the second player position hand to the final total count of the second hand at the dealer position;
the single game wager being resolved as follows:
a) if the first player position hand and the second player position hand both have higher final total counts higher than those of the first dealer position hand and the second dealer position hand, respectively, the game wager is won by the player position at 1:1 odds;
b) if one of the first player position hand and the second player position hand have a final total count that ties the final total count of its respective hand of the dealer position, the higher final total count of the other of the first and second respective hands determines winning or losing outcomes and if the other of the respective other hands tie, the side bet wager is a push, a player win or a dealer win according to a game rule; and
c) if the first player position hand and the second player position hand both have lower final total counts than those of the first dealer position hand and the second dealer position hand, respectively, the game wager is lost by the player position.
